(19) United States
(12) Patent Application Publication
(10) Pub. No.: US 2006/0129403 A1
(43) Pub. Date: Jun. 15, 2006

(54) Method and device for speech synthesizing and dialogue system thereof

(75) Inventors: Wen-wei Liao, Longtan Township (TW); Jia-lin Shen, Lujhou City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA ELECTRONICS, INC., Taoyuan Hsien (TW)

(21) Appl. No.: 11/299,634

(22) Filed: Dec. 12, 2005

(30) Foreign Application Priority Data
Dec. 13, 2004 (TW) 093138651

(51) Int. Cl. G10L 13/08

(52) U.S. Cl. 704/260

(57) ABSTRACT

A method and a device for speech synthesizing are provided. The method is used for generating a speech answer in a speech dialogue system, in which the speech dialogue system includes a speech recognizing process for recognizing a speech input inputted from a user to generate a textual answer. The method includes steps of extracting a speech prosody information of each of phonemes in the speech input, storing the speech prosody information in a database, providing a prosody model for producing an operational prosody information corresponding to a constituent structure of the textual answer, retrieving a corresponding speech prosody information of each phoneme based on at least parts of the constituent structure of the textual answer from the database, integrating the operational prosody information and the corresponding speech prosody information to generate an integrated prosody information of each phoneme corresponding to the constituent structure, and linking respectively the integrated prosody information of each phoneme corresponding to the constituent structure to generate the speech answer.

### FIELD OF THE INVENTION

The present invention is related to a method and a device for speech synthesizing and a dialogue system thereof, and more particularly to a method and a device for speech synthesizing which would enhance the quality of speech synthesizing by extracting phonemes from a speech input to adapt the speech output in a speech dialogue system.

### BACKGROUND OF THE INVENTION

With the development of the information technology, the time for information and automation is coming. Then, the interaction between human beings and computers is more common. Thus, a natural communication way with the computer is generated therewith,

Please refer to FIG. 1, which is a flow chart showing a conventional dialogue system with a speech communicating interface. The conventional dialogue system 10 includes a speech recognizing device 11 and a speech synthesizing device 15, in which a speech input inputted from a user is processed by the speech recognizing device 11 and the speech synthesizing device 15 to output a speech answer.

Further, the speech recognizing device 11 includes a speech recognizing module 12, a semantic understanding module 13 and a dialogue controlling module 14. The speech input is recognized by the speech recognizing module 12 to output a textual output. The textual output is understood by the semantic understanding module 13 to generate some significant structured information, such as the time, the location, the purpose of the user, etc. Then, other follow-up steps would be processed. In addition, the dialogue controlling module 14 would generate a corresponding answer, i.e. a textual answer shown in FIG. 1, to reply to the user according to the structured information. If the structured information is not enough to generate the corresponding answer, more information for the user could be inquired by the dialogue controlling module 14. According to the above inquiry and answer steps, a regular dialogue procedure would be generated therewith.

Furthermore, the speech synthesizing device 15 includes a text processing module 16, a prosody model 17, a prosody adjusting module 18 and a phoneme linking module 19. The text processing module 16 is used for analyzing a semantics structure and a grammar of the textual answer generated form the dialogue controlling module 14. Moreover, the prosody model 17 would generate a prosody information for each phoneme corresponding to the textual answer. Then, a speech output of the speech answer shown in FIG. 1 is generated by the prosody adjusting module 18 and the phoneme linking module 19 to adjust and link the prosody information.

Besides, a general speech dialogue system not only includes an understanding ability for the speech input but also includes an accurate pronunciation in the speech output. Further, a natural and fluency speech answer of the speech output should be enhanced. Thus, a prosody express in the speech answer would be considered in order to improve understanding in the semantics structure and comfort in the hearing.

According to the development of the speech synthesizing technique, values for prosody parameters could be estimated by a prosody model, and a better prosody model can provide more sensible prosody parameters. However, a device for synthesizing the speech answer, such as the speech synthesizing device 15 shown in FIG. 1, in the general speech dialogue system is often operated independently. For example, the textual answer is inputted into the speech synthesizing device 15 of FIG. 1 and the speech answer would be outputted therefrom. Thus, the speech synthesizing device 15 does not interact with other devices, and the prosody model 17 in the speech synthesizing device 15 only includes the original prosody parameters and would not be adapted by different conditions. According to the above description, the present speech dialogue system 10 always includes identical prosody expression and does not make progress in its speech output.

Therefore, the purpose of the present invention is to develop a method, a device and a system to deal with the above situations encountered in the prior art.

### SUMMARY OF TEE INVENTION

It is therefore a first aspect of the present invention to provide a method and a device for speech synthesizing and a dialogue system thereof, which could effectively enhance the natural and fluency ability for speech synthesizing by extracting corresponding phonemes from a speech input to integrate into the prosody parameters in a speech synthesizing process.

It is therefore a second aspect of the present invention to provide a method and a device for speech synthesizing and a dialogue system thereof, which include a prosody adapting process for prosody information of phonemes. The quality for speech synthesizing in a speech dialogue system is gradually enhanced by processing speech dialogues with multi-user to adapt prosody information of phonemes.

According to an aspect of the present invention, a speech synthesizing method for generating a speech answer in a speech dialogue system is provided, in which the speech dialogue system includes a speech recognizing process for recognizing a speech input inputted from a user to generate a textual answer. The method includes steps of (a) extracting a speech prosody information of each of phonemes in the speech input, (b) storing the speech prosody information in a database, (c) providing a prosody model for producing an operational prosody information corresponding to a constituent structure of the textual answer, (d) retrieving a corresponding speech prosody information of the each phoneme based on at least parts of the constituent structure of the textual answer from the database, (e) integrating the operational prosody information and the corresponding speech prosody information to generate an integrated prosody information of the each phoneme corresponding to the constituent structure, and (f) linking respectively the integrated prosody information of the each phoneme corresponding to the constituent structure to generate the speech answer.

Preferably, the step (b) further includes a step of calculating prosody parameters for the speech prosody information of the each phoneme in the speech input.

Preferably, the step (d) further includes a step of analyzing a semantic structure and a grammar of the constituent structure.

Preferably, the step (e) further includes following steps of (e1) calculating an occurrence probability for the each phoneme corresponding to the constituent structure in the database, (e2) providing a first weight for the corresponding speech prosody information according to the occurrence probability, (e3) providing a second weight for the operational prosody information according to the first weight, and (e4) providing the integrated prosody information of the each phoneme according to a weighting function.

Preferably, a sum of the first weight and the second weight is a constant and the constant would be 1.

Preferably, the speech prosody information, the operational prosody information and the integrated prosody information include prosody parameters of a duration, a pitch contour, an intensity and a break, respectively.

Preferably, the speech recognizing process includes a speech recognizing step, a semantic understanding step and a dialogue controlling step.

Preferably, the step (f) further includes a step of adjusting the integrated prosody information corresponding to the each phoneme in the speech answer.

According to another aspect of the present invention, a speech synthesizing device for generating a speech answer in a speech dialogue system is provided, in which the speech dialogue system includes a speech recognizing device for recognizing a speech input inputted from a user to generate a textual answer. The speech synthesizing device includes a prosody model for providing an operational prosody information for each of phonemes corresponding to a constituent structure of the textual answer, an extracting module for extracting a speech prosody information for the each phoneme in the speech input, a database for storing the speech prosody information, a controlling module disposed between the prosody model and the database for respectively retrieving the operational prosody information, retrieving a corresponding speech prosody information of the each phoneme based on at least parts of the constituent structure of the textual answer from the database according to the textual answer, and integrating the operational prosody information and the corresponding speech prosody information to generate an integrated prosody information of the each phoneme corresponding to the constituent structure, and a phoneme linking module for linking the integrated prosody information of the each phoneme corresponding to the constituent structure to generate the speech answer.

Preferably, the speech synthesizing device further includes a text processing module for analyzing a semantic structure and a grammar for the constituent structure of the textual answer.

Preferably, the speech synthesizing device further includes a prosody adjusting module for adjusting the integrated prosody information corresponding to each phoneme in the speech answer.

Preferably, the controlling module includes a determining unit and a calculating unit.

Preferably, the determining unit is used for determining an occurrence probability for the each phoneme corresponding to the constituent structure in the database to provide a first weight for the corresponding speech prosody information, and for providing a second weight for the operational prosody information of the each phoneme corresponding to the constituent structure according to the first weight.

Preferably, the calculating unit is used for providing the integrated prosody information of the each phoneme according to the first weight and the second weight,

Preferably, the speech recognizing device includes a speech recognizing module, a semantic understanding module and a dialogue controlling module.

According to another aspect of the present invention, a dialogue system is provided. The dialogue system includes a speech recognizing device for recognizing a speech input inputted by a user to generate a textual answer, and a speech synthesizing device for converting the textual answer into a speech answer, wherein the speech synthesizing device respectively is integrated with an operational prosody information corresponding to a constituent structure of the textual answer provided by a prosody model and a corresponding speech prosody information of the speech input based on at least parts of the constituent structure of the textual answer so as to generate the speech answer having a part of the speech input.

Preferably, the speech synthesizing device further includes a database for storing a speech prosody information extracted from the speech input.

Preferably, the speech synthesizing device further includes an extracting module for extracting the speech prosody information of each phoneme in the speech input and for storing the speech prosody information in the database.

Preferably, the speech synthesizing device further includes a controlling module for respectively retrieving and integrating the operational prosody information and a corresponding speech prosody information of the each phoneme according to the constituent structure of the textual answer to generate the integrated prosody information for each phoneme.

Preferably, the speech synthesizing device further includes a phoneme linking module respectively linking the integrated prosody information of each phoneme to generate the speech answer.

The above contents and advantages of the present invention will become more readily apparent to those ordinarily skilled in the art after reviewing the following detailed descriptions and accompanying drawings, in which:

### BRIEF DESCIPTION OF THE DRAWINGS

FIG. 1 is a flow chart showing a speech dialogue system according to the prior art; and

FIG. 2 is a flow chart showing a speech dialogue system according to a preferred embodiment of the present invention.

### DETAILED DESCRIPTION OF THE PREFERRED EMBODIMENTS

The present invention will now be described more specifically with reference to the following embodiment. It is to be noted that the following descriptions of preferred embodiment of this invention are presented herein for purpose of illustration and description only; it is not intended to be exhaustive or to be limited to the precise form disclosed.

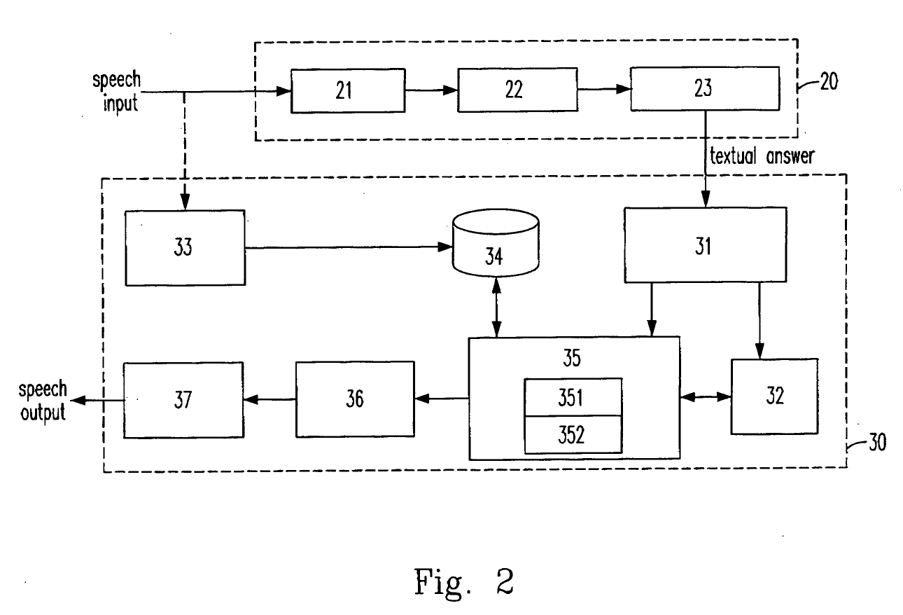

Please refer to FIG. 2, which is a flow chart showing a speech dialogue system according to a preferred embodiment of the present invention, wherein the present speech dialogue system includes a speech recognizing device 20 and a speech synthesizing device 30. The speech recognizing device 20 is used for recognizing a speech input inputted from a user to generate a textual answer, and the speech synthesizing device 30 is used for converting the textual answer into a speech answer.

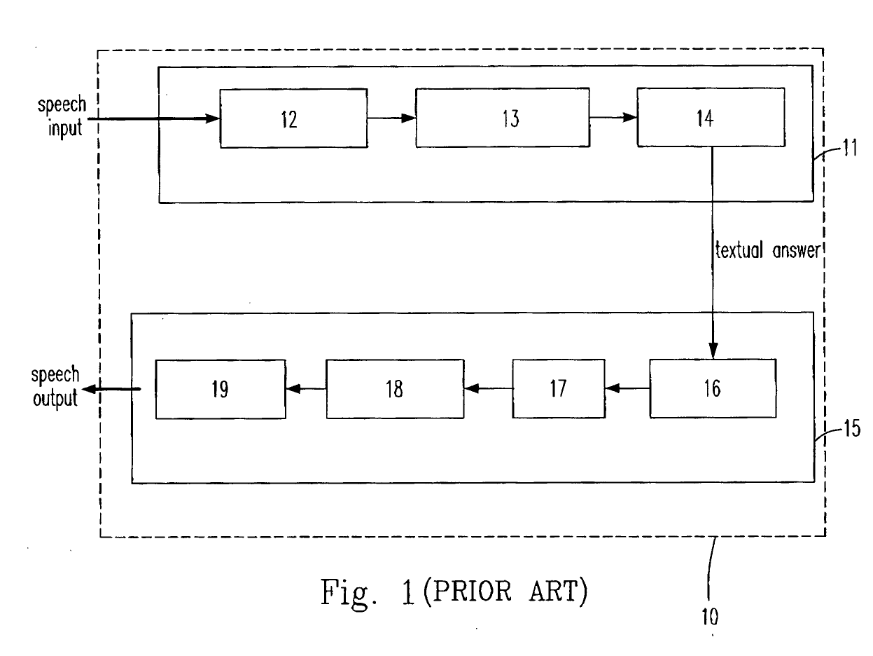

Further, the speech recognizing device 20 includes a speech recognizing module 21, a semantic understanding module 22 and a dialogue controlling module 23. The functions of these modules 21, 22 and 23 are similar to those of the prior modules 12, 13 and 14 shown in FIG. 1. The speech recognizing module 21 is used for recognizing the speech input to generate a textual output, the semantic understanding module 22 is used for converting the textual output into the significant structured information, and the dialogue controlling module 23 is used for processing the significant structured information to generate a textual answer.

Besides, the speech synthesizing device 30 includes a text processing module 31, a prosody model 32, an extracting module 33, a database 34, a controlling module 35, a prosody adjusting module 36 and a phoneme linking module 37. The text processing module 31 is used for analyzing a semantic structure and a grammar for the constituent structure of the textual answer to extract various language feature parameters therefrom, the extracting module 33 is used for extracting a prosody information for each phoneme in the speech input, and the database 34 is used for storing the prosody information from the extracting module 33. Further, these language feature parameters could provide some language feature information in the textual answer, such as which is the term, which is the sentence, what the articulation is, how to pronounce, which is the break and how long the break is and so on. Then, these language feature parameters would be transferred to the prosody model 32 for generating prosody parameters of a prosody information for each phoneme, such as a duration, a pitch contour, an intensity and a break (or called a pause). Further, the function of the present prosody model 32 is similar to that of the conventional prosody model 17 shown in FIG. 1, and the prosody model 32 includes some operation functions to compute the prosody parameters of the prosody information for each phoneme from the language feature parameters corresponding to the constituent structure of the textual answer.

Moreover, the technical feature disclosed in the present invention is concerned about integrating different prosody information from different information sources. In order to distinguish different prosody information, different prosody information from different source would be named, respectively. Accordingly, the prosody information computed by the prosody model 32 would be called an operational prosody information, the prosody information stored in the database 34 would be called a speech prosody information, and the prosody information after integrating the operational prosody information and the corresponding speech prosody information would be called an integrated prosody information.

Furthermore, the controlling module 35 is disposed between the prosody model 32 and the database 34. The controlling module 35 is used for respectively retrieving the operational prosody information from the prosody model 32 and retrieving a corresponding speech prosody information of each phoneme based on at least parts of the constituent structure of the textual answer from the database 34 according to the textual answer. Then, the operational prosody information from the prosody model 32 and the corresponding speech prosody information from the database 34 are integrated by the controlling module 35 to generate an integrated prosody information of each phoneme corresponding to the constituent structure. In addition, the integrated prosody information corresponding to each phoneme in the speech answer is adjusted by the prosody adjusting module 36, and the integrated prosody information of each phoneme corresponding to the constituent structure would be linked by the phoneme linking module 37 to generate the speech answer.

In a word, the extracting module 33 would extract the speech prosody information for each phoneme in the speech input when the user inputs the speech input. Further, the speech prosody information extracted from the extracting module 33 would be stored in the database 34. Generally, an input inputted from the user is related to its answer in a dialogue system. Thus, the present dialogue system would integrate the related speech input into the operation in prosody parameters for speech synthesizing, and thus the prosody expression for the speech answer would approach that in the real world.

Besides, a beginning time and an ending time for each phoneme in the speech input would be defined in advance according to the present invention while the speech prosody information for each phoneme in the speech input is extracted. However, the definition for the beginning time and the ending time in each phoneme of the speech input would be simply obtained by a process for recognizing the speech input, so that the present invention does not perform any extra operations. The operation for prosody parameters of various speech prosody information in each phoneme are as follows:

If signals in the speech input are assumed as [S₁, S₂, S₃ . . . S_{N}], then:

$$\begin{matrix}Duration \text{:} Duration = End - Begin & ( 1 ) \\ Pitch contour \text{:} \\ Pitch\_contour = GetPitchContour [ {S}_{Begin} … {S}_{End} ] & ( 2 ) \\ Intensity \text{:} Intensity = 10 {log ( \frac{{\sum }_{l = Begin}^{End} {S}_{i}^{2}}{End - Begin} )}^{1 / 2} & ( 3 ) \\ Break \text{:} Break = {Begin}_{( i + 1 )} - {End}_{( i )} & ( 4 )\end{matrix}$$

where End₍ᵢ₎ is the ending time for this phoneme, and Begin₍ᵢ₊₁₎ is the beginning time for next phoneme.

According to the above description, the extracting module 33 could extract the speech prosody information for each phoneme in the speech input and store the speech prosody information in the database 34. After more dialogues are performed with more users, the speech prosody information stored in the database 34 becomes richer and richer.

Therefore, the controlling module 35 would respectively retrieve the corresponding speech prosody information of each phoneme based on at least parts of the constituent structure of the textual answer from the database 34 and the operational prosody information from the prosody model 33, and then the controlling module 35 could integrate the operational prosody information with the corresponding speech prosody information to generate the integrated prosody information of each phoneme corresponding to the constituent structure. Moreover, the controlling module 35 includes a determining unit 351 and a calculating unit 352. The determining unit 351 is used for determining an occurrence probability for each phoneme corresponding to the constituent structure in the database 34 to provide a first weight for the corresponding speech prosody information according to said occurrence probability, and for providing a second weight for the operational prosody information of each phoneme corresponding to the constituent structure according to the first weight. Further, the calculating unit 352 is used for providing the integrated prosody information of each phoneme by a weighted average operation process according to the first weight and the second weight.

Further, an integrated operation mechanism in the prosody information for each phoneme could be obtained through the following equations:
Weight_{DB}=f(number_of_prosody_samples)∝number_of prosody_samples (5)
Weight_{DB}+Weight_{model}=1 (6)
Prosody=Weight_{DB}×P_{DB}+Weight_{modle}×P_{model} (7)
where Weight_{model} is the weight for the prosody model 33, i.e. the second weight, Weight_{DB} is the weight for the database 34, i.e. the first weight, P_{model} is the prosody information for the prosody model 33, P_{DB} is the prosody information for the database 34, and Prosody is the integrated prosody information.

The equation (5) shows that Weight_{DB} is directly proportional to the number of prosody information samples. Thus, more speech prosody information would be extracted from speech inputs for multi-user in the same phoneme, and a greater value for the first weight, i.e. Weight_{DB}, should be designed. In addition, a sum of the first weight and the second weight disclosed in the equation (6) is a constant, such as 1. Accordingly, the value for Weight_{DB} would be determined and the value for Weight_{model} would be generated therewith. Finally, the integrated prosody information in this phoneme would be determined according to the equation (7).

Take an example for synthesizing the speech answer “Delta Electronics”. If the phrase “Delta Electronics” includes a greater occurrence probability in speech inputs inputted from multi-user, the speech prosody information for the phrase “Delta Electronics” in the database 34 should include a better reliability, and the value for the first weight, as disclosed in the equation (5), would be designed to be increased. Further, the second weight for the operational prosody information in the prosody model 33 would be relatively decreased, as shown in the equation (6). On the contrary, some phrase is unusual in the speech inputs from the database 34, and then the number of prosody information samples for this phrase would be of little value to statistics. Thus, the first weight for the speech prosody information in this phrase would be decreased.

Therefore, the above integrated operation in the prosody information includes an adaptable prosody benefit for calculating various adaptable prosody parameters of the integrated prosody information in the speech synthesizing process. Furthermore, the prosody model 33 still provides standard operational prosody information for speech synthesizing even though the database 34 does not store any corresponding operational prosody information. Thus, the quality for speech synthesizing in the present dialogue system could be gradually enhanced by adjusting the weighted operation process in the prosody information for speech synthesizing.

According to the above descriptions, it is understood that a better, natural and fluency ability for speech synthesizing could be effectively achieved to improve an artificial or an inflexible speech output for speech synthesizing in the prior art. Furthermore, the present invention would be simply implemented by extracting corresponding phonemes from a speech input to integrate into the prosody parameters in a speech synthesizing process and to adapt the speech output in a speech dialogue system, thereby generating a more real speech sound.

In conclusion, it is understood that the present method and present device for speech synthesizing and the present dialogue system thereof would include an additional database to store speech inputs inputted from users and apply the above integrated operation mechanism to provide the integrated prosody information for speech synthesizing. Thus, the quality for speech synthesizing in a speech dialogue system would be gradually enhanced by processing speech dialogues with multi-user to adapt prosody information of phonemes.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A speech synthesizing method for generating a speech answer in a speech dialogue system, wherein said speech dialogue system includes a speech recognizing process for recognizing a speech input inputted from a user to generate a textual answer, said method comprising steps of:
(a) extracting a speech prosody information of each of phonemes in said speech input;
(b) storing said speech prosody information in a database;
(c) providing a prosody model for producing an operational prosody information corresponding to a constituent structure of said textual answer;
(d) retrieving a corresponding speech prosody information of said each phoneme based on at least parts of said constituent structure of said textual answer from said database;
(e) integrating said operational prosody information and said corresponding speech prosody information to generate an integrated prosody information of said each phoneme corresponding to said constituent structure; and
(f) linking respectively said integrated prosody information of said each phoneme corresponding to said constituent structure to generate said speech answer.

2. The method according to claim 1, wherein said step (b) further comprises a step of calculating prosody parameters for said speech prosody information of said each phoneme in said speech input.

3. The method according to claim 1, wherein said step (d) further comprises a step of analyzing a semantic structure and a grammar of said constituent structure.

4. The method according to claim 1, wherein said step (e) further comprises following steps of:
(e1) calculating an occurrence probability for said each phoneme corresponding to said constituent structure in said database;
(e2) providing a first weight for said corresponding speech prosody information according to said occurrence probability;
(e3) providing a second weight for said operational prosody information according to said first weight; and
(e4) providing said integrated prosody information of said each phoneme according to a weighting function.

5. The method according to claim 4, wherein a sum of said first weight and said second weight is a constant.

6. The method according to claim 5, wherein said constant is 1.

7. The method according to claim 1, wherein said speech prosody information, said operational prosody information and said integrated prosody information comprise prosody parameters of a duration, a pitch contour, an intensity and a break, respectively.

8. The method according to claim 1, wherein said speech recognizing process comprises a speech recognizing step, a semantic understanding step and a dialogue controlling step.

9. The method according to claim 1, wherein said step (f) further comprises a step of adjusting said integrated prosody information corresponding to said each phoneme in said speech answer.

10. A speech synthesizing device for generating a speech answer in a speech dialogue system, wherein said speech dialogue system includes a speech recognizing device for recognizing a speech input inputted from a user to generate a textual answer, comprising:
a prosody model for providing an operational prosody information for each of phonemes corresponding to a constituent structure of said textual answer;
an extracting module for extracting a speech prosody information for said each phoneme in said speech input,
a database for storing said speech prosody information;
a controlling module disposed between said prosody model and said database for respectively retrieving said operational prosody information, retrieving a corresponding speech prosody information of said each phoneme based on at least parts of said constituent structure of said textual answer from said database according to said textual answer, and integrating said operational prosody information and said corresponding speech prosody information to generate an integrated prosody information of said each phoneme corresponding to said constituent structure; and
a phoneme linking module for linking said integrated prosody information of said each phoneme corresponding to said constituent structure to generate said speech answer.

11. The speech synthesizing device according to claim 10, further comprising a text processing module for analyzing a semantic structure and a grammar for said constituent structure of said textual answer.

12. The speech synthesizing device according to claim 10, further comprising a prosody adjusting module for adjusting said integrated prosody information corresponding to said each phoneme in said speech answer.

13. The speech synthesizing device according to claim 10, wherein said controlling module comprises a determining unit and a calculating unit.

14. The speech synthesizing device according to claim 13, wherein said determining unit is used for determining an occurrence probability for said each phoneme corresponding to said constituent structure in said database to provide a first weight for said corresponding speech prosody information, and for providing a second weight for said operational prosody information of said each phoneme corresponding to said constituent structure according to said first weight.

15. The speech synthesizing device according to claim 14, wherein said calculating unit is used for providing said integrated prosody information of said each phoneme according to said first weight and said second weight.

16. The speech synthesizing device according to claim 10, wherein said speech recognizing device comprises a speech recognizing module, a semantic understanding module and a dialogue controlling module.

17. A dialogue system, comprising:
a speech recognizing device for recognizing a speech input inputted by a user to generate a textual answer; and
a speech synthesizing device for converting said textual answer into a speech answer, wherein said speech synthesizing device respectively is integrated with an operational prosody information corresponding to a constituent structure of said textual answer provided by a prosody model and a corresponding speech prosody information of said speech input based on at least parts of said constituent structure of said textual answer so as to generate said speech answer having a part of said speech input.

18. The dialogue system according to claim 17, wherein said speech synthesizing device further comprises a database for storing a speech prosody information extracted from said speech input.

19. The dialogue system according to claim 18, wherein said speech synthesizing device further comprises an extracting module for extracting said speech prosody information of each phoneme in said speech input and for storing said speech prosody information in said database.

20. The dialogue system according to claim 19, wherein said speech synthesizing device further comprises a controlling module for respectively retrieving and integrating said operational prosody information and a corresponding speech prosody information of said each phoneme according to said constituent structure of said textual answer to generate said integrated prosody information for said each phoneme.

21. The dialogue system according to claim 20, wherein said speech synthesizing device further comprises a phoneme linking module respectively linking said integrated prosody information of said each phoneme to generate said speech answer.
